(19) United States
(12) Patent Application Publication
(10) Pub. No.: US 2009/0015221 A1
(43) Pub. Date: Jan. 15, 2009

(54) VOLTAGE GENERATING APPARATUS

(75) Inventor: Satoshi Kodera, Tatekbayashi-shi (JP)

Correspondence Address: MARTINE PENILLA & GENCARELLA, LLP, 710 LAKEWAY DRIVE, SUITE 200, SUNNYVALE, CA, 94085, US

(73) Assignee: ADVANTEST CORPORATION, Tokyo (JP)

(21) Appl. No.: 12/122,642

(22) Filed: May 16, 2008

(30) Foreign Application Priority Data
May 18, 2007 (JP) JP2007-132586

(51) Int. Cl. G05F 1/565

(52) U.S. Cl. 323/279

(57) ABSTRACT

A voltage generating apparatus generates an output voltage based on an input voltage. A voltage generator includes a first operational amplifier operative to receive the input voltage and a feedback voltage proportional to the output voltage. The voltage generator regulates the output voltage so that a virtual short circuit is produced in the first operational amplifier. An output capacitor smoothes the output voltage generated by the voltage generating apparatus. A sense signal generator detects a current flowing in the output capacitor and generates a sense signal proportional to the current detected. An adder-subtractor circuit superimposes the sense signal on at least one of the input and the output of the first operational amplifier.

### CLAIM OF PRIORITY

This application claims foreign priority for Japanese application number JP2007-132586, filed May 18, 2007.

### BACKGROUND OF INVENTION

1. Field of the Invention

The present invention relates to a voltage generation technology for generating a stable voltage.

2. Description of the Related Art

DC test equipment is used to measure various characteristics of electronic circuits. DC test equipment is provided with the function of supplying a desired stable voltage to a terminal of a device under test (hereinafter, referred to as DUT) and monitoring a current flowing into the terminal. Generally, DC test equipment is provided with a digital-to-analog converter (hereinafter, referred to as a DA converter) for converting an input digital signal into an analog voltage, a voltage generating apparatus for generating a stable output voltage with reference to the analog voltage from the DA converter, and an analog-to-digital converter (hereinafter, referred to as an AD converter) for converting a current that flows from the voltage generating apparatus to the DUT into a digital value (see, for example, FIG. 5 of patent document 1).

The voltage generating apparatus regulates the output voltage using feedback so that the analog voltage from the DA converter and the feedback voltage proportional to the output voltage fulfill a predetermined relation. An output capacitor for smoothing the output voltage is provided at the output terminal of the voltage generating apparatus. The output capacitor operates to maintain the output voltage at a stable level in the event of variation in a load. [patent document No. 1] JP 2004-20256

It should be noted, however, the feedback loop in the voltage generating apparatus has a finite bandwidth. The bandwidth of the feedback loop is limited due to the bandwidth of an operational amplifier used in the voltage generating apparatus and a filter formed by the output impedance of the voltage generating apparatus and the output capacitor. Particularly, when a sense resistor is provided on a path leading from the voltage generating apparatus to the DUT in order to monitor the current flowing into the DUT, the effective output impedance of the voltage generating apparatus is increased due to the sense resistor, with the result that the bandwidth of the feedback loop is narrowed and the response speed of the circuit is decreased. This will cause failure of the charging and discharging of the output capacitor by the voltage generating apparatus to follow an abrupt change in a load current, resulting in variation in the output voltage. Problems like this could occur not only in the voltage generating apparatus in DC test equipment but also in other voltage generating apparatus.

### SUMMARY OF THE INVENTION

In this background, a general purpose of the present invention is to provide a voltage generating apparatus in which the load characteristics indicating variation in a load is improved.

One aspect of the present invention relates to a voltage generating apparatus for generating an output voltage based on an input voltage. The voltage generating apparatus comprises: a voltage generator including a first operational amplifier operative to receive the input voltage and a feedback voltage proportional to the output voltage, and operative to regulate and output the output voltage so that a virtual short circuit is produced in the first operational amplifier; an output capacitor operative to smooth the output voltage generated by the voltage generator; a sense signal generator operative to detect a current flowing in the output capacitor and generate a sense signal proportional to the current detected; and an adder-subtractor circuit operative to superimpose the sense signal on at least one of the input and the output of the first operational amplifier.

The term “the current flowing in the output capacitor” refers to the current flowing in a path that includes the output capacitor. For example, the term refers to a current that flows in the forward direction or reverse direction in a path leading from the output terminal at which the output voltage occurs to a fixed voltage terminal (ground terminal) via the output capacitor.

When a delay occurs in supplying a current from the voltage generating apparatus to the load in the event of an abrupt change in a load current, deficiency is addressed by supplying a current from the charge stored in the output capacitor. By monitoring the current flowing in the output capacitor, a sense signal representative of the variation in the load is generated. In this aspect, the output voltage is regulated by forcibly correcting the feedback state, by superimposing the sense signal on the input or output of the first operational amplifier and thereby allowing the output voltage to approach a predetermined target value.

The voltage generator may include: a first input resistor operative to receive the input voltage at one end and connected to one input of the first operational amplifier at the other end; and a second input resistor operative to receive the feedback voltage at one end and connected to the one input of the first operational amplifier at the other end, wherein a fixed voltage is applied to the other input of the first operational amplifier. The adder-subtractor circuit may superimpose the sense signal on the output of the first operational amplifier.

In this case, the output voltage is regulated without being affected by the response speed of the first operational amplifier since the sense signal is superimposed on the output of the first operational amplifier.

The adder-subtractor circuit may include: a second operational amplifier operative to receive the fixed voltage at one input, receive the sense signal at the other input via the first adder resistor, and receive the output voltage of the first operational amplifier via the second adder resistor; and a feedback resistor provided between the output terminal of the second operational amplifier and the other input thereof.

The sense signal generator may include: a sense resistor provided between the output capacitor and a fixed voltage terminal; and an amplifier operative to amplify a voltage drop across the sense resistor and generate the sense signal. Denoting the resistance of the first adder resistor as Ra1, the resistance of the feedback resistor as Rfb, the DC output resistance of the voltage generator as Rz, the resistance of the sense resistor as Rs, and the gain of the operational amplifier as G1, the relation Rs×G1×Rfb/Ra1=Rz may be fulfilled. In this case, the variation in the output voltage is minimized.

The adder-subtractor circuit may include: a second operational amplifier operative to receive the output voltage of the first operational amplifier at one input via the second adder resistor, receive the sense signal at the other input via a fourth adder resistor, and receive the fixed voltage via a fifth adder resistor; and a feedback resistor provided between the output terminal of the second operational amplifier and the other input thereof.

In this case, the sense signal is superimposed on the fixed voltage input to the other input of the second operational amplifier.

The voltage generator may include: a first input resistor operative to receive the input voltage at one end and connected to one input of the first operational amplifier at the other end; and a second input resistor operative to receive the feedback voltage at one end and connected to the one input of the first operational amplifier at the other end, wherein a fixed voltage is applied to the other input of the first operational amplifier. In this configuration,

(1) the adder-subtractor circuit may superimpose the sense signal on the feedback voltage and applies the resultant voltage to the one input of the first operational amplifier.

(2) The adder-subtractor circuit may superimpose the sense signal on the input voltage and applies the resultant voltage to the one input of the first operational amplifier.

(3) The adder-subtractor circuit may superimpose the sense signal on the fixed voltage and applies the resultant voltage to the one input of the first operational amplifier.

In the case of (1)-(3), the sense signal is superimposed on the input of the first operational amplifier. Therefore, the sense signal can be amplified according to the gain of the first operational amplifier and reflected in the output voltage.

The voltage generating apparatus may further comprise: a filter operative to filter the sense signal and supply the filtered signal to the adder-subtractor circuit. By providing a filter, frequency components suitable for the purpose of regulating the output voltage can be extracted from the frequency components of the current flowing in the output capacitor. Accordingly, the output voltage is further regulated.

Preferably, the filter is a high pass filter. As the current flowing in the output capacitor changes abruptly as a result of a change in the load, the sense signal will contain high-frequency components-immediately after the change. Thereafter, there will be less high-frequency components. Thus, by providing a high pass filter, the peak current immediately after the change can be reflected in the correction of the output voltage.

The voltage generating apparatus may further comprise: a peak hold circuit operative to hold the peak value of the sense signal and supply the value to the adder-subtractor circuit. By adjusting the decay time constant of the peak hold circuit, the correction of the output voltage can be adjusted.

Another aspect of the present invention also relates to a voltage generating apparatus for generating an output voltage based on an input voltage. The voltage generating apparatus comprises: a voltage generator operative to regulate and output the output voltage using feedback so that a predetermined relation holds between the input voltage and a feedback voltage proportional to the output voltage; an output capacitor operative to smooth the output voltage generated by the voltage generator; a sense signal generator operative to detect a current flowing in the output capacitor and generate a sense signal proportional to the current detected. The voltage generator causes the feedback based on the sense signal to be reflected in the feedback based on the output voltage.

Still another aspect of the present invention relates to direct current test equipment for monitoring a current flowing in a device under test while applying a DC current to the device under test. The direct current test equipment comprises: the voltage generating apparatus according to any one of the aspects described above; and a current measuring unit operative to measure a current flowing from the output terminal of the voltage generating apparatus to the load.

According to this aspect, the DC voltage supplied to the device under test is regulated in the event of an abrupt change in the electrical condition of the device under test and a resultant change in the current. Therefore, accurate tests can be performed.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of DC test equipment according to the first embodiment;

FIG. 2 is a circuit diagram showing a specific exemplary structure of the voltage generating apparatus 100 of FIG. 1;

FIGS. 3A and 3B are waveform charts illustrating the operation of the voltage generating apparatus of FIGS. 1 and 2;

FIG. 4 is a waveform chart that results when the high pass filter in the voltage generating apparatus of FIG. 2 is not provided;

FIG. 5 is a circuit diagram showing the structure of a voltage generating apparatus according to the first variation;

FIG. 6 is a circuit diagram showing the structure of a voltage generating apparatus according to the second variation; and

FIG. 7 is a circuit diagram showing the structure of a voltage generating apparatus according to the second embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

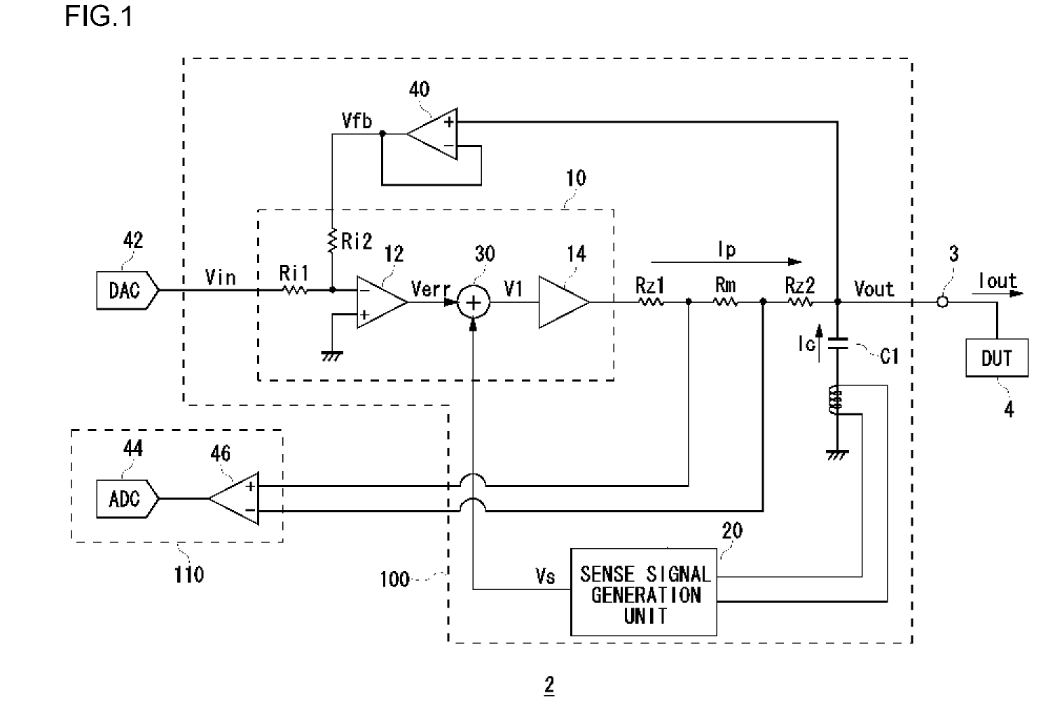

FIG. 1 is a circuit diagram of DC test equipment 2 according to the first embodiment. The DC test equipment 2 is provided with an output terminal 3 adapted to be connected to a DUT 4. The DC test equipment 2 outputs a DC voltage Vout to the DUT 4 via the output terminal 3 and monitors a current Iout flowing into the DUT 4 while the DC voltage Vout is being applied to the DUT 4.

The DC test equipment 2 includes a voltage generating apparatus 100, a voltage measuring unit 110, and a DA converter 42. The voltage generating apparatus 100 generates a stable DC voltage (hereinafter, also referred to as an output voltage) Vout. The DA converter 42 is fed a digital value configured by the user and converts the digital value into an analog voltage for output. The voltage generating apparatus 100 receives the output of the DA converter 42 as an input voltage Vin. The voltage generating apparatus 100 generates the output voltage Vout with reference to the input voltage Vin. The DC test equipment 2 may be built in semiconductor test equipment.

A current measuring resistor Rm is provided on a path of a current Iout from the output unit of the voltage generating apparatus 100. The current measuring unit 110 includes an amplifier 46 for amplifying a voltage drop across the current measuring resistor Rm provided in the voltage generating apparatus 100, and an AD converter 44 for subjecting the output of the amplifier to analog-to-digital conversion. The output of the AD converter 44 is subject to predetermined signal processing before being displayed on a display (not shown) or stored in a storage means. Described above is an overall structure of the DC test equipment 2.

A description will be given of the structure of the voltage generating apparatus 100 according to this embodiment. The voltage generating apparatus 100 is provided with a voltage generator 10, an output capacitor C1, a sense signal generator 20, an adder-subtractor circuit 30, and a feedback buffer 40.

The voltage generator 10 regulates the output voltage Vout using feedback. The output voltage Vout at the output terminal 3 is fed back to the input via the feedback buffer 40. The feedback buffer 40 is a voltage follower using an operational amplifier. The feedback buffer 40 prevents the current from being leaked from the output of the voltage generator 10 to the input thereof. The output of the feedback buffer 40 will be referred to as a feedback voltage Vfb. In the circuit of FIG. 1, the feedback voltage Vfb is equal to the output voltage Vout. Alternatively, the feedback voltage Vfb may be generated by dividing the output voltage Vout.

The voltage generator 10 includes a first operational amplifier 12 that receives the input voltage Vin and the feedback voltage Vfg proportional to the output voltage Vout and amplifies an error between the two voltages.

The first operational amplifier 12 is provided in the feedback loop and functions as an error amplifier. The voltage generator 10 adjusts the output voltage Vout so that virtual short is established in the first operational amplifier 12, i.e., so that the potential at the non-inverting input and that of the inverting input are identical. The output of the first operational amplifier 12 is also referred to as an error voltage Verr since it depends on an error between the input voltage Vin and the output voltage Vout.

The voltage generator 10 may comprise a non-inverting amplifier instead of an inverting amplifier as described in this embodiment. Alternatively, the generator 10 may comprise a linear regulator (LDO) or a switching regulator for regulating the output voltage by using feedback via an error amplifier.

The output capacitor C1 is provided between the output terminal 3 and a fixed voltage terminal (grounding terminal) and smoothes the output voltage Vout generated by the voltage generator 10.

The sense signal generator 20 senses a current Ic flowing in the output capacitor C1 (hereinafter, also referred to as a capacitor current) so as to generate a sense signal Vs proportional to the capacitor current Ic thus detected. The method of sensing may not be as described above. Voltage drop across a resistor provided on a path of the capacitor current Ic or voltage induced in a coil on the path may be used.

In addition to the first operational amplifier 12, the voltage generator 10 includes a first input resistor Ri1, a second input resistor Ri2, and an output buffer 14. One end of the first input resistor Ri1 receives the input voltage Vin and the other end thereof is connected to one input (inverting input) of the first operational amplifier 12. One end of the second input resistor Ri2 receives the feedback voltage Vfb and the other end thereof is connected to one input (inverting input) of the first operational amplifier 12. A fixed voltage (ground voltage) is applied to the other input (non-inverting input) of the first operational amplifier 12.

When virtual short is established in the first operational amplifier 12, the following relation holds between the output voltage Vout (=Vfb) and the input voltage Vin.

Vout=−Ri2/Ri1×Vin (1)

In other words, the error voltage Verr is produced so that the above relation holds.

The output buffer 14 outputs the error voltage Verr as the output voltage Vout. Referring to FIG. 1, Rz1 and Rz2 represent DC output resistance (impedance) of the voltage generating apparatus 100 caused, for example, by wire resistance.

In the circuit of FIG. 1, the adder-subtractor circuit 30 is formed as part of the voltage generator 10. The adder-subtractor circuit 30 superimposes the sense signal Vs on at least one of the input and the output of the first operational amplifier 12. The adder-subtractor circuit 30 is provided at the output of the first operational amplifier 12 and superimposes the sense signal Vs on the error voltage Verr, which is the output of the first operational amplifier 12. The output of the adder-subtractor circuit 30 (hereinafter, referred to as a synthesized voltage V1) is fed to the output buffer 14.

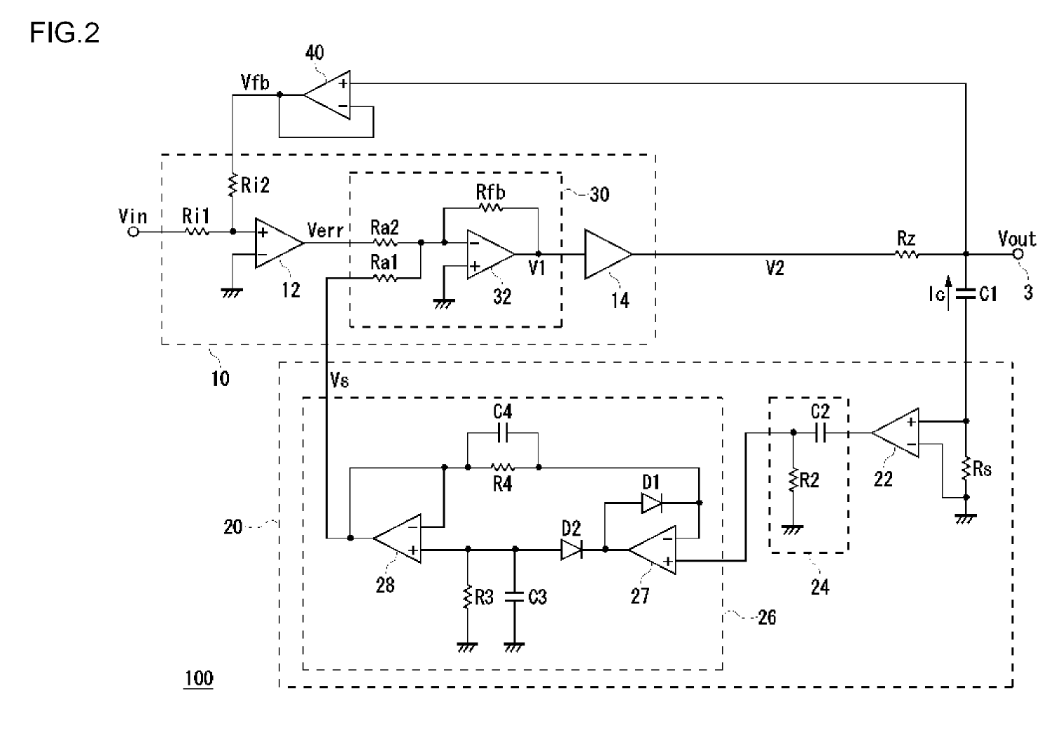

FIG. 2 is a circuit diagram showing a specific exemplary structure of the voltage generating apparatus 100 of FIG. 1. The adder-subtractor circuit 30 is formed as an inverting adder including a second operational amplifier 32, a first adder resistor Ra1, a second adder resistor Ra2, and a feedback resistor Rfb.

The ground voltage (fixed voltage) is fed to one input (non-inverting input) of the second operational amplifier 32. The other input (inverting input) of the second operational amplifier 32 is fed the sense signal Vs via the first adder resistor Ra1 and the error voltage Verr, the output of the first operational amplifier 12, via the second adder resistor Ra2. The feedback resistor Rfb is provided between the output of the second operational amplifier 32 and the other input (inverting input) thereof. The synthesized voltage V1 is given by

V1=−Rfb(Vs/Ra1+Verr/Ra2) (2)

The adder-subtractor circuit 30 superimposes the sense signal Vs on the error voltage Verr.

The inverting input and the non-inverting input of the first operational amplifier 12 as illustrated in FIG. 2 are reversed with respect to those of the first operational amplifier 12 of FIG. 1. This is because the adder-subtractor circuit 30 of FIG. 2 is formed as an inverting adder.

The sense signal generator 20 includes a sense resistor Rs, an amplifier 22, a high pass filter 24, and a peak hold circuit 26.

The sense resistor Rs is provided on a path of the current Ic flowing in the output capacitor C1. More specifically, the resistor Rs is provided between the output capacitor C1 and the fixed voltage terminal (ground terminal). The amplifier 22 amplifies a voltage drop across the sense resistor Rs so as to generate the sense signal Vs.

Given that the resistance of the first adder resistor Ra1 is denoted by Ra1, the resistance of the feedback resistor Rfb as Rfb, the DC output resistance of the voltage generator 10 as Rz, the resistance of the sense resistor Rs as Rs, and the gain of the amplifier 22 as G1, it is preferable that the resistances and the gain are set such that

Rs×G1×Rfb/Ra1=Rz (3)

The reason for this will be described later. The gain G1 of the amplifier 22 includes the gain of the high pass filter 24 and the peak hold circuit 26 and substantially represents the entirety of the sense signal generator 20. To enable fine adjustment, it is preferable that at least one of the resistors is formed as a variable resistor and a trimmable resistor.

The high pass filter 24 filters the sense signal Vs so as to extract only the high-frequency components. The peak hold circuit 26 holds the peak value of the sense signal Vs output from the high pass filter 24 and supplies the value to the adder-subtractor circuit 30. Referring to FIG. 2, the high pass filter 24 is formed as a first-order filter including a capacitor C2 and a resistor R2.

The peak hold circuit 26 includes operational amplifiers 27 and 28, diodes D1 and D2, resistors R3 and R4, and capacitors C3 and C4.

The non-inverting input of the operational amplifier 27 is connected to the output of the high pass filter 24. The diode D1 is connected between the inverting input and the output of the operational amplifier 27 such that the anode thereof is connected to the output. The cathode of the diode D2 is connected to the output of the operational amplifier 27 and the anode thereof is connected to the non-inverting input of the operational amplifier 28. The resistor R3 and the capacitor C3 are provided in parallel between the non-inverting input of the operational amplifier 28 and the ground terminal. The operational amplifier 28 is a voltage follower (buffer) and the output signal of the operational amplifier 28 is fed back to the inverting input of the operational amplifier 27 via the resistor R4 and the capacitor C4 connected in parallel.

The peak hold circuit 26 holds the peak value of the output voltage of the high pass filter 24 and outputs the sense signal Vs attenuated according to the time constant determined by the resistor R3 and the capacitor C3.

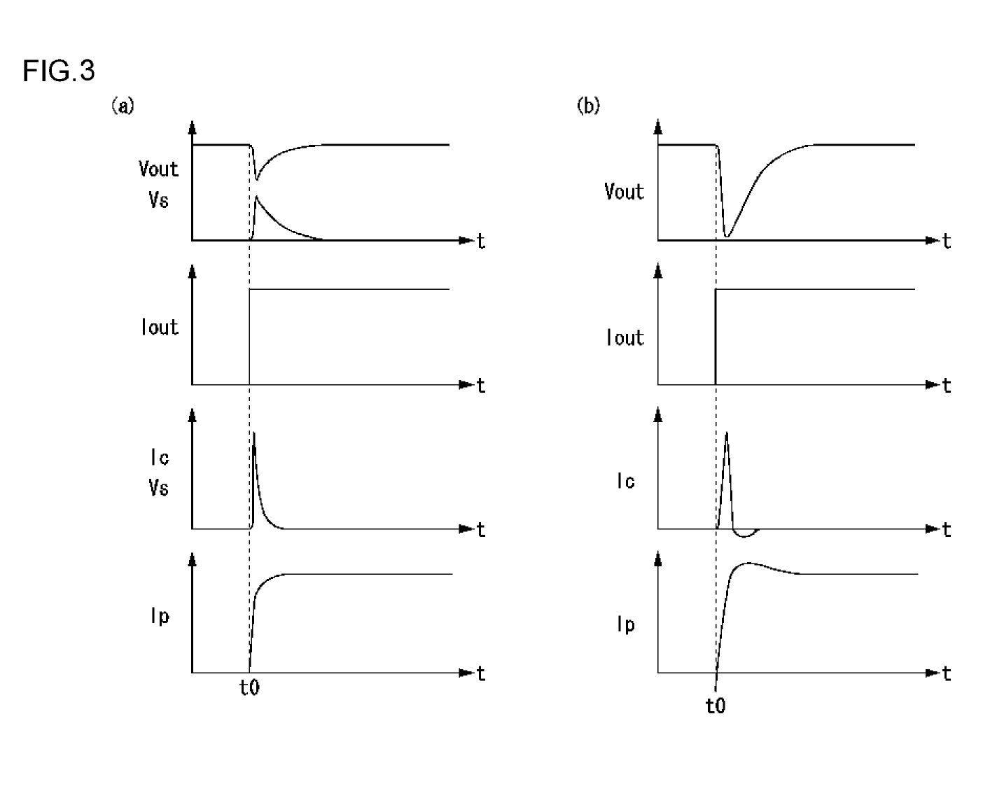

A description will now be given of the operation of the voltage generating apparatus 100 of FIGS. 1 and 2. FIGS. 3A and 3B are waveform charts illustrating the operation of the voltage generating apparatus 100 of FIGS. 1 and 2. FIG. 3A shows the operation of the circuit of FIGS. 1 and 2, and FIG. 3B shows the operation of the circuit not provided with the sense signal generator 20 and the adder-subtractor circuit 30. FIGS. 3A and 3B show, from top to bottom, the output voltage Vout (Vfb) and the sense signal Vs, the load current Iout, the current Ic flowing in the output capacitor C1, and the output current Ip of the voltage generator 10. The vertical and horizontal axes of the waveform charts are enlarged or reduced for ease of understanding. Also, the waveform charts are simplified for ease of understanding.

To let the advantage of the voltage generator 10 according to this embodiment be appreciated properly, a description will be given of the operation of the related-art circuit not provided with the sense signal generator 20 and the adder-subtractor circuit 30 with reference to FIG. 3B.

Before time t0, the load current Iout is maintained at a constant level and the output voltage Vout is regulated to a predetermined value. The load current Iout, the current Ic flowing in the output capacitor C1, and the output current of the voltage generator 10 are related such that

Iout=Ip+Ic (4)

In the stationary state before time t0, Ic=0 and Iout=Ip.

At time t0, the operating condition of the DUT 4 changes so that the load current Iout is increased abruptly. When a delay occurs in the supply of the output current Ip from the voltage generator 10 due to the bandwidth constraints of the voltage generator 10, the deficiency is addressed by supplying the charge stored in the output capacitor C1. The discharge current flows in the output capacitor C1 as the capacitor current Ic. When the output capacitor C1 is discharged, the output voltage Vout drops. Thereafter, feedback control is performed so that the output voltage Vout approximates the input voltage Vin. The output voltage will return to its original value with time.

As described, the related art circuit has a problem in that the output voltage Vout varies considerably due to the abrupt change in the load current Iout.

A description will now be given, with reference to FIG. 3A, of the operation of the voltage generating apparatus 100 according to this embodiment. At time t0, the load current Iout is increased abruptly. A delay in the feedback response results in an increase in the capacitor current Ic. The capacitor current Ic is converted into the sense signal Vs by the sense resistor Rs and the amplifier 22. The sense signal Vs has a peak value proportional to the capacitor current Ic and is attenuated according to the time constant set in the peak hold circuit 26.

The sense signal Vs thus generated is superimposed by the adder-subtractor circuit 30 on the feedback component (Vfb) proportional to the output voltage Vout. Thereby, the error voltage Verr is corrected in the direction in which the output voltage Vout is increased, with the result that the synthesized voltage V1 is increased. As a result, the output voltage Vout is decreased by an amount smaller than in the case of FIG. 3B even when the bandwidth of feedback is narrower than the speed of change of the load current Iout. Consequently, the load variation characteristic is improved.

Once the circuit is in a stable state, the capacitor current Ic becomes 0 so that the sense signal Vs becomes 0. The signal no longer provides contribution to the feedback based on the output voltage Vout. The stable output voltage Vout continues to be produced as in the related art.

From an alternative perspective, the voltage generator 10 causes the feedback based on the sense signal Vs to be reflected in the feedback based on the output voltage Vout (Vfb). As a result, even when the output voltage Vout follows a change with a delay, feedback control based on the sense signal Vs takes effect so that the amount of variation in the output voltage Vout is controlled or the time required for the output voltage Vout to be regulated is reduced.

A description will now be given of why the resistances and the gain should be set so that expression (3) holds. It will be assumed that the load current Iout has varied by an amount ΔIout at time t0, and the output voltage of the output buffer 14 in FIG. 2 is denoted by V2. Before time t0, the following relation holds.

V2=Vout+Rz×Iout (5)

Subsequent to time t0, the following relation holds.

V2′=Vout+Rz×(Iout+ΔIout) (6)

In order to ensure that the output voltage Vout remains the same before and after the change in the load, the following relation should hold.

V2′−V2=Rz×ΔIout (7)

Since the amount of variation ΔIout is approximated as being equal to the capacitor current Ic, the output voltage V2 of the output buffer 14 should be increased subsequent to the change in the load by an amount

ΔV2=V2′−V2=Rz×Ic (8)

ΔV2 represents an amount by which the synthesized voltage V2 is increased by the adder-subtractor circuit 30 in accordance with the sense signal Vs.
Expression (2) provides that ΔV2 is given by the following expression.

ΔV2=Rfb(Vs/Ra1) (9)

Variation in the output voltage Vout is minimized if the following relation holds.

Rz×Ic=Rfb(Vs/Ra1) (10)

Meanwhile, the sense signal Vs is given by

Vs=Ic×Rs×G1 (11)

Using expressions (10) and (11), expression (3) already listed can be obtained.

Rs×G1×Rfb/Ra1=Rz (3)

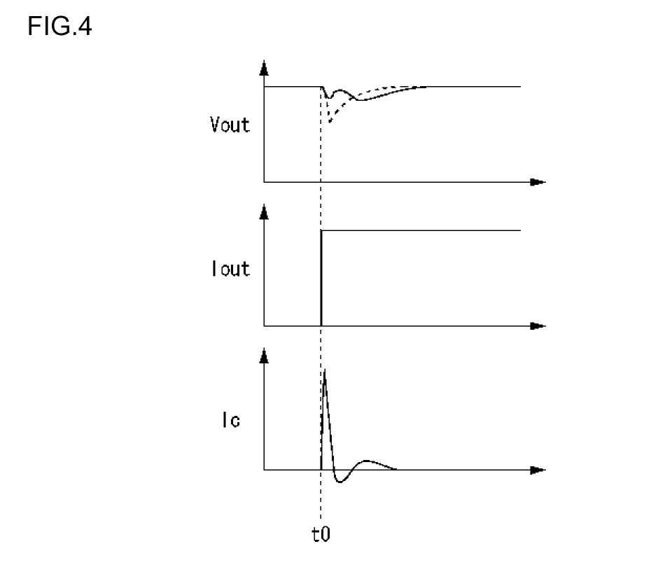

The difference in the advantages provided when the high pass filter 24 is used and when it is not will be discussed. FIG. 4 is a waveform chart that results when the high pass filter 24 for filtering the output voltage Vout is not provided. For the purpose of comparison, the output voltage Vout that results when the high pass filter 24 is provided is indicated by a broken line. If the high pass filter 24 is not provided, the low frequency components of the capacitor current Ic contributes to the control of the output voltage Vout, allowing the variation in the output voltage Vout to be further reduced. Therefore, it is desirable not to provide the high pass filter 24 if the amount of variation in the output voltage Vout is to be reduced. Conversely, it is desirable to provide the high pass filter 24 if the time required for the output voltage Vout to converge to a predetermined value is to be reduced. In other words, the high pass filter 24 may be or may not be provided depending on the application intended. By setting the cut-off frequency of the high pass filter 24 low, an intermediate characteristic is obtained. A band pass filter may be used instead of a high pass filter.

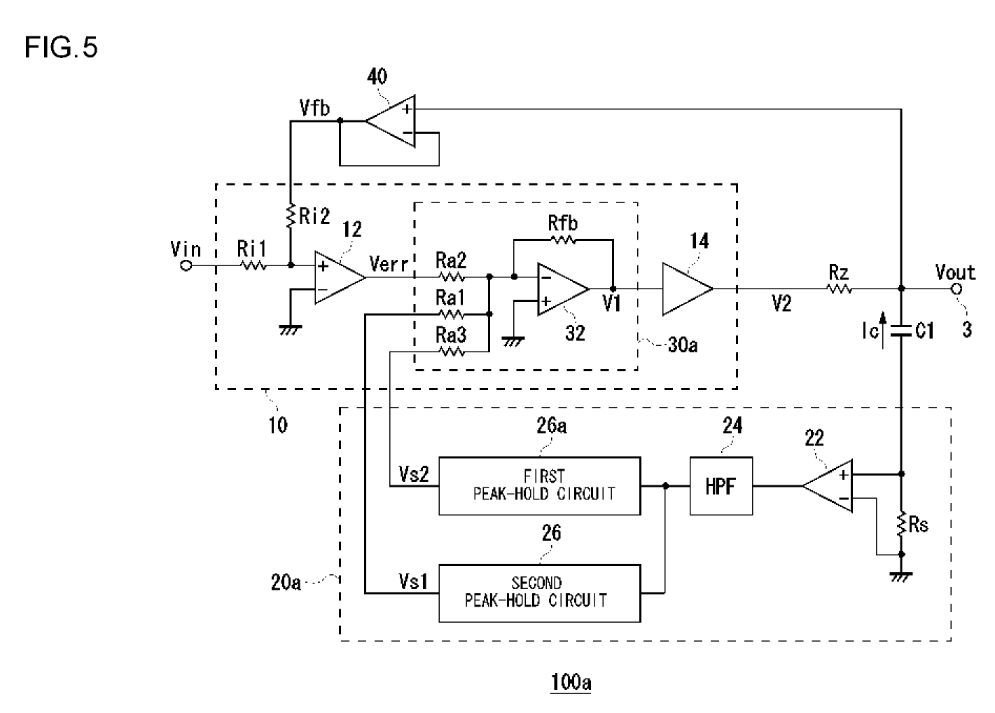

A description will now be given of a variation of the voltage generating apparatus 100 according to the first embodiment. FIG. 5 is a circuit diagram showing the structure of a voltage generating apparatus 100a according to the first variation. In the circuits of FIGS. 1 and 2, it is assumed that the load current Iout is increased so that the current Ic flows from the output capacitor C1 to the load. In the variation of FIG. 5, the circuit is provided with the function to regulate the output voltage Vout when the load current Iout flows from the load. The current flows from the load to the output capacitor C1 when the load current Iout is decreased abruptly or when the current Ic swings in the negative direction due to ringing.

In addition to the features of FIG. 2, the voltage generating apparatus 10a according to the variation of FIG. 5 is provided with a second peak hold circuit 26a provided in parallel with the peak hold circuit 26. The anodes and cathodes of the diodes D1 and D2 of the peak hold circuit 26a are reversed with respect to those of the peak hold circuit 26 of FIG. 2.

The adder-subtractor circuit 30a of the voltage generating apparatus 100a of FIG. 5 is further provided with a third adder resistor Ra3. The output of the peak hold circuit 26a is applied to the inverting input of the second operational amplifier 32 via the third adder resistor Ra3.

According to the voltage generating apparatus 10a of FIG. 5, the output voltage Vout is corrected irrespective of the direction of flow of the current Ic. In other words, the output voltage Vout is regulated regardless of whether the output voltage Vout is a positive voltage or a negative voltage. In still another variation, only the peak hold circuit 26a may be provided.

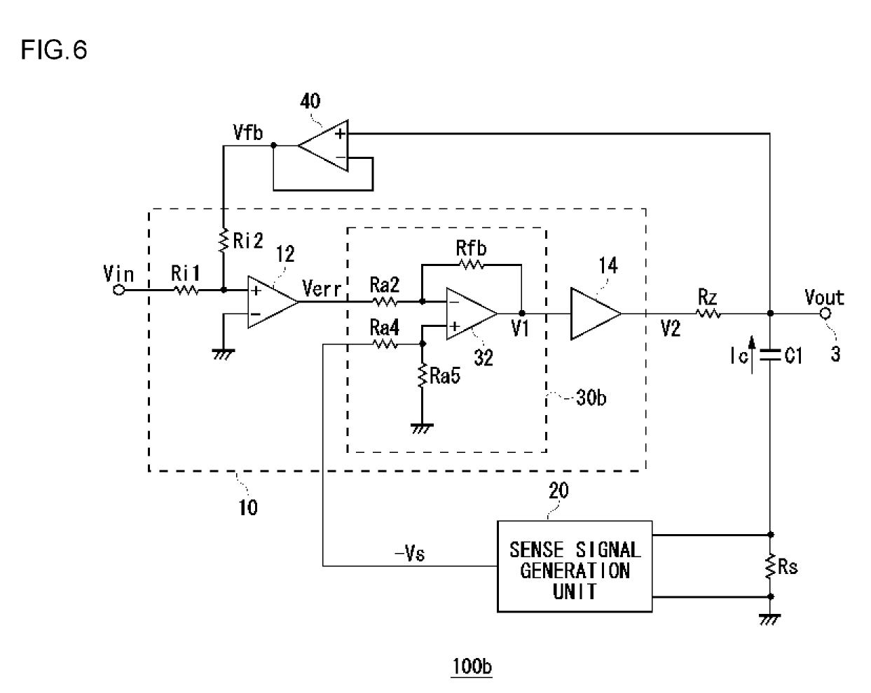

FIG. 6 is a circuit diagram showing the structure of a voltage generating apparatus 100b according to the second variation. The output voltage Verr of the first operational amplifier 12 is fed to one input (inverting input) of the second operational amplifier 32 via the second adder resistor Ra2. The other input (non-inverting input) of the second operational amplifier 32 is fed the sense signal Vs via the fourth adder resistor Ra4 and the ground voltage via the fifth adder resistor Ra5. The sense signal Vs is inverted by the sense signal generator 20 before being supplied. Inversion may be performed by using, for example, an operational amplifier.

The variation of FIG. 6 can provide the same advantage as the circuit of FIG. 2.

### Second embodiment

In the first embodiment, a description is given of the superimposition of the sense signal Vs proportional to the capacitor current Ic on the output of the first operational amplifier 12. In contrast, a description will be given in the second embodiment of the superimposition of the sense signal Vs on the input to the first operational amplifier 12.

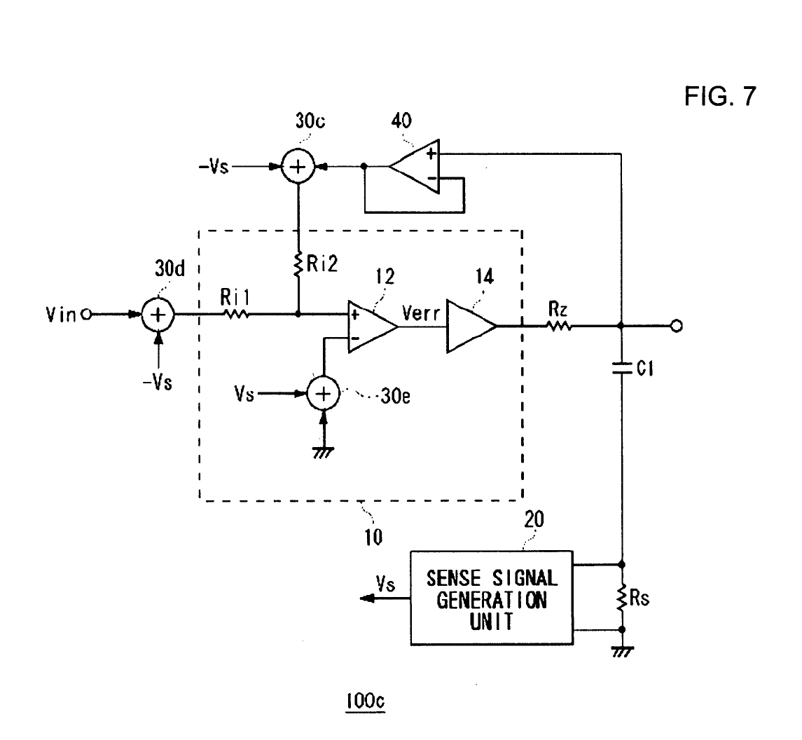

FIG. 7 is a circuit diagram showing the structure of a voltage generating apparatus 100c according to the second embodiment. Three adder-subtractor circuits 30c-30e of the voltage generating apparatus 100c represent points where the sense signal Vs may be superimposed. Only one of the circuits 30c-30e may be provided.

(1) The adder-subtractor circuit 30c superimposes the sense signal Vs on the feedback voltage Vfb (Vout). In this case, the sense signal Vs is inverted before superimposition. By superimposing the inverted sense signal Vs on the feedback voltage Vfb, the first operational amplifier 12 determines that the output voltage Vout is low. As a result, strong feedback is provided so as to increase the output voltage Vout.

(2) The adder-subtractor circuit 30 superimposes the sense signal Vs on the input voltage Vin. Since the first operational amplifier 12 is an inverting amplifier, the sense signal Vs is inverted before superposition.

(3) The adder-subtractor circuit 30e superimposes the sense signal Vs on the ground voltage and applies the resultant voltage to the other input (inverting input) of the first operational amplifier 12. As the sense signal Vs is increased, the output voltage Verr of the first operational amplifier 12 is increased so that the output voltage Vout is increased.

In other words, the sign of the sense signal Vs is set so that the output voltage Vout is corrected to be increased when the current flowing in the output capacitor C1 is increased.

According to the second embodiment, the sense signal Vs is superimposed on the input of the first operational amplifier 12 so that the following advantage is provided in addition to the advantage of the first embodiment. Referring to the circuit of FIG. 7, the signal with the sense signal Vs superimposed thereon is amplified by the first operational amplifier 32. Accordingly, correction of the output voltage Vout based on the sense signal Vs can be configured in accordance with the gain of the first operational amplifier.

The embodiments described above are illustrative only and a number of variations to the structure and processing steps could be made. Some such variations will be described.

In the embodiments described, the voltage generator 10 is formed as an inverting amplifier or a non-inverting amplifier. The generator 10 may be formed otherwise. For example, the voltage generating technology for controlling the output voltage so that it approaches a reference voltage by means of a linear regulator or a switching regulator may be used to form the voltage generator 10. In the case of a linear regulator, for example, the output buffer 14 is replaced by an output transistor. The output voltage Verr of the first operational amplifier 12 is applied to the gate (base) of the output transistor, the first terminal of the output transistor is connected to the power supply, and the second terminal is connected to the output terminal 3. In the case of the voltage generator 10 formed as a switching regulator, pulse width modulation may be performed based on the output voltage Verr of the first operational amplifier 12 so as to control the switching element.

In the embodiments described, the current Ic flowing in the output capacitor C1 is converted into a voltage and superimposed on the feedback loop as the sense signal Vs. Alternatively, the current may be added or subtracted.

It is assumed that the voltage generating apparatus 100 is used in the DC test equipment 2. Alternatively, the generator 100 may be used for a variety of applications that require a stable voltage.

While the preferred embodiments of the present invention have been described using specific terms, such description is for illustrative purposes only, and it is to be understood that changes and variations may be made without departing from the spirit or scope of the appended claims.

What is claimed is:

1. A voltage generating apparatus for generating an output voltage based on an input voltage, comprising:
a voltage generator including a first operational amplifier operative to receive the input voltage and a feedback voltage proportional to the output voltage, and operative to regulate and output the output voltage so that a virtual short circuit is produced in the first operational amplifier;
an output capacitor operative to smooth the output voltage generated by the voltage generator;
a sense signal generator operative to detect a current flowing in the output capacitor and generate a sense signal proportional to the current detected; and
an adder-subtractor circuit operative to superimpose the sense signal on at least one of the input and the output of the first operational amplifier.

2. The voltage generating apparatus according to claim 1, wherein the voltage generator includes:
a first input resistor operative to receive the input voltage at one end and connected to one input of the first operational amplifier at the other end; and
a second input resistor operative to receive the feedback voltage at one end and connected to the one input of the first operational amplifier at the other endr wherein a fixed voltage is applied to the other input of the first operational amplifier and the adder-subtractor circuit superimposes the sense signal on the output of the first operational amplifier.

3. The voltage generating apparatus according to claim 2, wherein the adder-subtractor circuit includes:
a second operational amplifier operative to receive the fixed voltage at one input receive the sense signal at the other input via the first adder resistor and receive the output voltage of the first operational amplifier via the second adder resistor; and
a feedback resistor provided between the output terminal of the second operational amplifier and the other input thereof.

4. The voltage generating apparatus according to claim 3, wherein the sense signal generator includes:
a sense resistor provided between the output capacitor and a fixed voltage terminal; and
an amplifier operative to amplify a voltage drop across the sense resistor and generate the sense signal, and denoting the resistance of the first adder resistor as Ra1, the resistance of the feedback resistor as Rfb, the DC output resistance of the voltage generator as Rz, the resistance of the sense resistor as Rs, and the gain of the operational amplifier as G1, the relation
Rs×G1×Rfb/Ra1=Rz
is fulfilled.

5. The voltage generating apparatus according to claim 2, wherein the adder-subtractor circuit includes:
a second operational amplifier operative to receive the output voltage of the first operational amplifier at one input via the second adder resistor, receive the sense signal at the other input via a fourth adder resistor, and receive the fixed voltage via a fifth adder resistor; and
a feedback resistor provided between the output terminal of the second operational amplifier and the other input thereof.

6. The voltage generating apparatus according to claim 1, wherein the voltage generator includes:
a first input resistor operative to receive the input voltage at one end and connected to one input of the first operational amplifier at the other end; and
a second input resistor operative to receive the feedback voltage at one end and connected to the one input of the first operational amplifier at the other end, wherein a fixed voltage is applied to the other input of the first operational amplifier, and the adder-subtractor circuit superimposes the sense signal on the feedback voltage.

7. The voltage generating apparatus according to claim 1, wherein the voltage generator includes:
a first input resistor operative to receive the input voltage at one end and connected to one input of the first operational amplifier at the other end; and
a second input resistor operative to receive the feedback voltage at one end and connected to the one input of the first operational amplifier at the other end, wherein a fixed voltage is applied to the other input of the first operational amplifier, and the adder-subtractor circuit superimposes the sense signal on the input voltage.

8. The voltage generating apparatus according to claim 1, wherein the voltage generator includes:
a first input resistor operative to receive the input voltage at one end and connected to one input of the first operational amplifier at the other end; and
a second input resistor operative to receive the feedback voltage at one end and connected to the one input of the first operational amplifier at the other end, wherein a fixed voltage is applied to the other input of the first operational amplifier, and
the adder-subtractor circuit superimposes the sense signal on the fixed voltage.

9. The voltage generating apparatus according to claim 1, further comprising:
a filter operative to filter the sense signal and supply the filtered signal to the adder-subtractor circuit.

10. The voltage generating apparatus according to claims 1, further comprising:
a peak hold circuit operative to hold the peak value of the sense signal and supply the value to the adder-subtractor circuit.

11. A voltage generating apparatus for generating an output voltage based on an input voltage, comprising:
a voltage generator operative to regulate and output the output voltage using feedback so that a predetermined relation holds between the input voltage and a feedback voltage proportional to the output voltage;
an output capacitor operative to smooth the output voltage generated by the voltage generator;
a sense signal generator operative to detect a current flowing in the output capacitor and generate a sense signal proportional to the current detected, wherein the voltage generator causes the feedback based on the sense signal to be reflected in the feedback based on the output voltage.

12. Direct current test equipment comprising:
the voltage generating apparatus according to claim 1; and
a current measuring unit operative to measure a current flowing from the output terminal of the voltage generating apparatus to a load.
